(19) United States
(12) Patent Application Publication
(10) Pub. No.: US 2026/0192492 A1
(43) Pub. Date: Jul. 9, 2026

(54) Method and Apparatus for Producing Fine Rubber Powder from Waste Tires

(71) Applicant: Qingdao Goldenway Resource & Technology Co., Ltd., Qingdao City (CN)

(72) Inventors: Yuhai Gao, Qingdao City (CN); Xingyuan Gao, Qingdao City (CN); Fei Sun, Qingdao City (CN); Lingjun Lu, Qingdao City (CN); Haolin Li, Qingdao City (CN)

(21) Appl. No.: 19/424,015

(22) Filed: Dec. 17, 2025

(30) Foreign Application Priority Data
Dec. 18, 2024 (CN) 202411874550.6

(51) Int. Cl. B29B 17/04; B29B 17/02

(52) U.S. Cl. CPC B29B 17/0404; B29B 17/0206; B29B 2017/0272; B29B 2017/0428; B29B 2017/0448

(57) ABSTRACT

Disclosed by the present disclosure are a method and apparatus for producing fine rubber powder from waste tires, which belong to the field of rubber powder production. To solve the problem of high iron impurity content in rubber powder after existing mechanical pulverization, the method for producing fine rubber powder from waste tires sequentially includes: Step 1: separating a waste tire between a sidewall and a shoulder to obtain a tire annular band; and Step 2: applying a water jet to the tire annular band by a crushing water jet cutter to cut it into a flocculent rubber structure; and grinding the flocculent rubber structure on the surface of the tire annular band by a grinding assembly into fine rubber powder.

### RELATED APPLICATIONS

This application claims priority to Chinese Patent Application No. 202411874550.6, filed on Dec. 18, 2024, which is hereby incorporated by reference in its entirety.

### TECHNICAL FIELD

The present disclosure relates to the technical field of rubber powder production, and particularly to a method and apparatus for producing fine rubber powder from waste tires.

### BACKGROUND

Waste tires refer to tires that have been replaced or discarded and thus lost their service value, as well as scrapped tires produced in factories. With social development, the number of private cars and commercial vehicles has been increasing rapidly, which leads to a sharp rise in the annual volume of waste tires. The accumulation of a large number of waste tires not only poses potential safety hazards such as fire risks, but also causes “black pollution” to the environment. At present, automobile tires are mostly radial tires. Generally, a radial tire consists of three materials: rubber, steel wire, and fiber. The most commonly used recycling method for waste tires is mechanical pulverization. When processing waste tires into rubber powder by mechanical pulverization, the tires are usually cut into strips and then into blocks; the rubber blocks are pulverized to obtain crude rubber powder, which is subjected to primary iron removal; the rubber powder is then subjected to repeated pulverization, iron removal, and sieving to obtain the target rubber powder.

The rubber powder produced by mechanical pulverization generally has a relatively large particle diameter, and is usually processed into rubber powder of 20 to 100 mesh. For rubber powder above 100 mesh, repeated pulverization, iron removal and sieving are required. Moreover, the particle diameter distribution is wide, and only part of the target rubber powder above 100 mesh can be obtained through sieving. Specifically, a method of crushing tires by mechanical pulverization can be found in the Chinese Patent Application Publication No. CN104002394A, published on Aug. 27, 2014, which discloses a process for producing rubber powder from waste tires, including the steps of bead separation, strip cutting, block cutting, and then pulverization and magnetic separation of waste tires. The process of pulverization and magnetic separation is as follows: 1) the tire blocks are crushed and sieved by a coarse crusher to obtain coarse particles of 8 to 10 mesh, which are subjected to first magnetic separation to obtain steel wires and coarse rubber particles, and the steel wires are recovered; 2) the coarse rubber particles are subjected to second magnetic separation to obtain pure coarse rubber particles and a small amount of rubber particles containing the steel wires, and the rubber particles containing the steel wires are returned to the coarse crusher for further crushing; and 3) the pure coarse rubber particles are pulverized by a pulverizer and then sieved to obtain rubber powder.

The Chinese Patent Application Publication No. CN1923486A, published on Mar. 7, 2007, discloses a method and apparatus for preparing rubber powder from waste tires based on water jet technology. The method includes the steps of: a) placing a waste tire on a rotating support, and positioning the waste tire within an effective cutting range of a rotary water jet head with a water pressure higher than 200 MPa, such that the distance between the waste tire and the rotary water jet head is 4 to 5 cm; two or more rotary water jet heads are mounted above each tire, each rotary water jet head is provided with 3 to 5 water nozzles, and pneumatic or hydraulic power for high-speed rotation is applied to the rotating structure of each rotary water jet head, such that the high-speed water jet ejected from the water nozzles rotates under the action of a rotating mechanism to form a high-speed rotating water jet; b) rotating the waste tire at a low speed, while causing the rotary water jet head to rotate and reciprocate along an arc-shaped track; through the combined movement of the waste tire and the rotary water jet head, together with the cutting effect generated by the strong kinetic energy of the water jet, the rubber on the waste tire is processed into powder, and the metal wires in the waste tire are separated from the rubber; and c) subjecting the water-containing powdered rubber to subsequent recovery treatment to obtain the rubber powder processed from the waste tire according to the present disclosure. The apparatus includes a waste tire rubber pulverizing and separating machine, which mainly includes a high-pressure water generation device, a rotary water jet head, a waste tire support, and a water tank, wherein an output of the high-pressure water generation device is connected to an input end of the rotary water jet head; the rotary water jet head is mounted on an arc-shaped swinging device arranged above the water tank; the waste tire support, on which the waste tire is mounted, is supported in the water tank below the rotary water jet head and is connected to a driving mechanism for driving the waste tire support to rotate; the water tank is connected to subsequent processing equipment through a drain outlet or a water pump; the rotary water jet head is a multi-nozzle rotary water jet head, at least two rotary water jet heads are mounted on each swinging device, and the distance between the nozzle and the waste tire is 4 to 5 cm.

In the above technical solution, by mainly setting the water pressure (greater than 200 MPa) of a water cutting head and the distance (1 to 10 cm) between the water cutting head and the tire, the rubber on the tire surface is pulverized into powder by the action force of a water flow from the water cutting head. During processing, the beads of the waste tire are supported by the supporting rods of the waste tire support. When the water flow from the water cutting head acts on the beads, the beads vibrate, thereby affecting the processing of the rubber powder and resulting in poor particle uniformity of the produced rubber powder. In addition, the rubber close to the steel wire layers is difficult to separate completely. When secondary processing is carried out by increasing the pressure of the water jet and reducing the cutting distance, the steel wire layers of the tire are easily damaged, which causes a large amount of steel wire debris to be mixed in the rubber powder. Multiple subsequent magnetic separation and impurity removal steps are then required, which affects processing efficiency.

### SUMMARY

For efficiently production of rubber powder with low iron impurity content from waste tires, the present disclosure provides a method and apparatus for producing fine rubber powder from waste tires. The method for producing fine rubber powder from waste tires combines water jet crushing and grinding crushing, which enables efficient processing of rubber powder from waste tires and produces rubber powder with low iron impurity content.

The present disclosure adopts the following technical solutions to solve the technical problem.

A method for producing fine rubber powder from waste tires, sequentially including:
Step 1: separating a waste tire between a sidewall and a shoulder to obtain a tire annular band including a tread and the shoulder; and
Step 2: maintaining the tire annular band in a tensioned state and rotating it circumferentially; cutting, by a water jet from a crushing water jet cutter reciprocating in an axial direction of the tire annular band, a surface of the tire annular band into a flocculent rubber structure not separated from the tire annular band; and grinding, by a grinding assembly, the flocculent rubber structure on the surface of the tire annular band into fine rubber powder separated from the tire annular band.

Through the above technical solution, by removing the sidewall of the tire, the portion of the tire subjected to water jet processing is formed into a regular annular band, so that when the tire annular band is mounted on a support provided with a plurality of support rollers, the tire annular band can be well tensioned to maintain a stable tensioned state. Moreover, when the tire annular band is driven to perform a circumferential circulating motion by the support rollers and/or a grinding wheel, the tire annular band can move in a stable and controllable state and trajectory, thereby realizing the process control of the crushing of the tire annular band by a water jet device, so as to achieve a high-quality, stable and controllable rubber powder morphology.

When the tire annular band is in circumferential circulating rotation between the grinding wheel and the support rollers, by setting the position and parameters of the water jet device, the water jet generated by the water jet device crushes the surface of the tire annular band, so that the rubber material on the surface of the tire annular band forms a flocculent structure not separated from a steel wire mesh. Further, through the grinding action of the grinding wheel on the tire annular band, the rubber of the flocculent structure on the surface of the tire annular band forms rubber powder separated from the tire annular band. Such processing does not damage a steel wire layer in the tire, so that the resulting rubber powder contains very few iron impurities, and conventional magnetic separation for iron removal is no longer required.

The water jet has extremely high kinetic energy. When the rubber on the tire annular band is pulverized, thermal energy generated by a chemical bond breakage and thermal energy converted from the kinetic energy may cause a high temperature of the rubber powder. Further, due to the small particle diameter, the rubber powder particles are also highly prone to agglomeration. By mixing the prepared rubber powder with a water stream or introducing it into a collection container filled with water, on the one hand, the water stream is used to rapidly cool the rubber powder, and on the other hand, the hydrophobicity of the rubber powder surface is exploited to disperse the rubber powder via the water stream, thereby preventing the rubber powder from agglomerating.

Optionally, the Step 2 sequentially includes:
Step 2.1: applying a water jet to the tire annular band by the crushing water jet cutter to cut a surface of the tire annular band into a flocculent rubber structure not separated from the tire annular band; and
Step 2.2: grinding the flocculent rubber structure on the surface of the tire annular band by the grinding assembly.

Through the above technical solution, the sequential use of water jet and grinding enables efficient processing of rubber powder from waste tires and produces rubber powder with low iron impurity content.

Optionally, the method for producing fine rubber powder from waste tires further includes: Step 3: removing impurities from the fine rubber powder;

The Step 3 sequentially includes:
Step 3.1: placing the fine rubber powder into a collection container filled with water;
Step 3.2: performing magnetic separation on the fine rubber powder using a magnetic separator to remove iron; and
Step 3.3: draining and drying the fine rubber powder.

Through the above technical solution, the fine rubber powder is subjected to magnetic separation for iron removal, such that the resulting rubber powder has a low iron impurity content.

Optionally, the method for producing fine rubber powder from waste tires further includes: Step 4: freezing and pulverizing the fine rubber powder to obtain ultra-fine rubber powder;

The Step 4 sequentially includes:
Step 4.1: placing the fine rubber powder into an environment of −130° C. to −70° C. for mechanical crushing, to obtain secondary rubber powder with a particle diameter ranging from 100 μm to 500 μm;
Step 4.2: sequentially placing the secondary rubber powder into pre-freezing bins for pre-freezing at a pre-freezing temperature of −60° C. to −30° C. for a pre-freezing time of 20 s to 200 s;
Step 4.3: placing the pre-frozen secondary rubber powder into a deep-freezing bin for deep freezing at a deep freezing temperature of −196° C. to −80° C. for a deep freezing time of 60 s to 200 s; and
Step 4.4: grinding the deep-frozen secondary rubber powder to obtain the ultra-fine rubber powder.

Through the above technical solution, molecular motion of rubber almost completely ceases in a low-temperature environment of −130° C. to −70° C., and the material becomes extremely hard and brittle. Rubber in this state is prone to fracture under impact or pressure, and less energy is required during pulverization, thereby effectively improving pulverization efficiency. In addition, low-temperature pulverization reduces heat generated by friction, avoids the risk of pyrolysis or oxidation of rubber caused by frictional heat, and maintains the chemical stability of the rubber powder. After primary crushing of rubber at −130° C. to −70° C., the rubber powder is pre-frozen at −60° C. to −30° C. Since the pre-freezing temperature is higher than that during mechanical crushing, molecular motion of the rubber recovers to a certain extent, the material regains partial toughness, and rubber molecular chains are elongated due to stress release. After pre-freezing, the rubber powder is subjected to deep freezing. The instantaneous temperature difference between deep freezing and pre-freezing causes the elongated rubber molecular chains to break. Further, rapid crystallization of rubber occurs at −196° C. to −80° C. At this point, grinding and crushing the secondary rubber powder not only produces finer rubber powder, but also rearranges the molecular chains of the rubber powder, thereby improving the mechanical properties of the material.

Optionally, in Step 4.2, temperatures of the pre-freezing bins decrease stage by stage from a feed end to a discharge end for the secondary rubber powder with a temperature difference of 10° C. to 15° C. between adjacent stages, and treatment time in the the pre-freezing bins reduce stage by stage, with a time difference of 30 s to 60 s between adjacent stages.

Staged temperature reduction allows more uniform cooling of the rubber powder and avoids the internal stress or non-uniform crystallization caused by an excessively rapid temperature change. Controlling a temperature difference of 10° C. to 15° C. between adjacent stages helps the rubber powder to reach different physical states at different stages, facilitates the ordered arrangement of rubber molecular chains, and improves crystallization quality. Controlling a time difference of 30 s to 60 s between adjacent stages ensures sufficient time for the molecular rearrangement and crystallization of the rubber powder at each temperature stage, and prevents the degradation of material properties caused by excessively long exposure at a certain temperature. As the temperature decreases, the crystallization rate of the rubber powder gradually increases, so shortening the treatment time gradually avoids excessive crystallization or excessive molecular chain arrangement. Through gradual temperature reduction and time control, the crystallization process of the rubber powder is optimized to form more uniform and finer crystals at different temperatures, thereby improving the physical properties of the rubber powder.

Optionally, in Step 2, the grinding assembly includes a grinding wheel, which applies a pressure of 7000 N to 10000 N onto the tire annular band.

Through the above technical solution, by controlling the pressure applied by the grinding wheel to the tire annular band, the grinding effect of the grinding wheel on the flocculent rubber on the tire annular band can be controlled.

Optionally, in Step 2, an intensity of a water jet of the crushing water jet cutter is 280 MPa to 400 MPa, and a standoff distance of the crushing water jet cutter is 15 mm to 50 mm.

Through the above technical solution, by controlling the water jet intensity and the target distance, a good crushing effect of the water jet on the tire annular band can be ensured.

Optionally, in Step 2, a circumferential rotational speed of the tire annular band is 500 mm/min to 1500 mm/min.

Through the above technical solution, when the tire annular band moves too rapidly, the contact time between the water jet and the cutting unit of the tire annular band is insufficient, preventing effective cutting and crushing of the surface of the tire annular band. When the tire annular band moves too slowly, the prolonged contact time between the water jet and the cutting unit of the tire annular band causes excessive cutting depth, damaging the steel wire mesh and introducing iron impurities. This also leads to localized overheating, adversely affecting the physical and chemical properties of the rubber powder. By controlling and adjusting the movement speed of the tire annular band, the processing efficiency and the processing quality of rubber powder crushing are fully coordinated during the processing of the tire annular band.

Optionally, in Step 2, the grinding assembly includes a grinding wheel, an outer circumferential surface of which is provided with diamond patterns, or linear stripes extending along an axial direction of the grinding wheel.

Through the above technical solution, by providing diamond patterns or linear stripes on the surface of the grinding wheel, the friction coefficient on the surface of the grinding wheel is increased. Accordingly, when the tire annular band moves, the flocculent rubber on the surface of the tire annular band can be effectively ground.

Optionally, in Step 2, the grinding assembly includes a grinding wheel, a rotation direction of which is opposite to that of the tire annular band.

Through the above technical solution, grinding and cutting of the flocculent rubber are further facilitated to obtain the fine rubber powder.

Optionally, in Step 2, a mass fraction of the fine rubber powder with a mesh size of 200 mesh to 300 mesh is 65% to 95%.

Through the above technical solution, the fine rubber powder can be finer.

Optionally, in Step 1, a gripping device is disposed to grip an outer rim of the waste tire, or a support device is disposed to support an inner rim of the waste tire; the gripping device or the support device is driven to rotate by a driving device, causing the waste tire to rotate around its axis, and when the waste tire (11) rotates, a cutting water jet parallel to the axis of the waste tire is aligned with a joint position between the sidewall and the shoulder, and the sidewall and the shoulder are separated from each other under the action of the water jet ejected from the water jet cutter.

Through the above technical solution, by rotating the tire and cutting and separating the sidewall from the shoulder of the tire by the water jet ejected by the water jet cutter, the process is efficient, convenient, and environmentally friendly.

Optionally, in Step 3.1, when the fine rubber powder is placed into the collection container filled with water, the collection container is equipped with a stirring device and an ultrasonic oscillation device.

Through the above technical solution, mechanical stirring and ultrasonic oscillation enable more efficient and sufficient dispersion of the rubber powder, such that agglomeration of the rubber powder particles is less likely to occur.

An apparatus for producing fine rubber powder from waste tires, which is adopted by the method for producing fine rubber powder from waste tires, the apparatus for producing fine rubber powder from waste tires including a cutting device and a water jet pulverizing device;
the cutting device is configured to separate the waste tire by cutting between a sidewall and a shoulder;
the water jet pulverizing device includes a grinding assembly, a water jet assembly, a transmission driving assembly, and a plurality of support rollers;
the tire annular band is capable of being mounted around the plurality of support rollers that maintain the tire annular band in the tensioned state, and the transmission driving assembly is configured to drive the tire annular band to rotate circumferentially through the support rollers;
the water jet assembly includes a crushing water jet cutter, which is configured to apply the water jet to the tire annular band to cut the surface of the tire annular band into the flocculent rubber structure not separated from the tire annular band; and
the grinding assembly includes a grinding wheel, which is configured to grind the flocculent rubber structure on the surface of the tire annular band.

Through the above technical solution, the rotation driving assembly drives the support assembly or the gripping assembly to rotate, so that the motion trajectory of the cutting water jet cutter relative to the tire is a regular circle. The water jet of the cutting water jet cutter separates the sidewall from the shoulder, thereby maintaining a regular shape for the tire annular band to be mounted conveniently. Further, the tire annular band is mounted around the support rollers and tensioned by the support rollers, and then the grinding wheel is positioned to abut against the tire annular band. When the transmission driving assembly drives the tire annular band to move between the grinding wheel and the support roller, the water jet ejected from the crushing water jet cutter crushes the surface of the tire annular band, so that the rubber material on the surface of the tire annular band forms a flocculent structure not separated from the steel wire layer. Then, under the grinding action of the grinding wheel on the tire annular band, the rubber powder is gradually separated from the tire annular band. In this apparatus, the tire annular band is preliminarily broken by the water jet cutter, so that the rubber material on the surface of the tire annular band forms a flocculent structure not separated from the steel wire layer. The rubber powder is then separated from the tire annular band by abrasion, which hardly damages the steel wire layer. Accordingly, the content of iron impurities in the rubber powder is low, and the rubber powder with an extremely low iron content can be obtained only by one magnetic separation, thereby effectively improving the production efficiency of the rubber powder.

Optionally, the cutting device is a water jet cutting device, and the cutting device includes a tire fixing assembly, a cutting water jet cutter, and a driving assembly. The tire fixing assembly is a gripping assembly or a support assembly, the gripping assembly is configured to grip and fix an outer rim of the waste tire, and the support assembly is configured to support and fix an inner rim of the waste tire. The cutting water jet cutter configured to cut the waste tire, and the driving assembly is configured to drive the tire fixing assembly to rotate.

Optionally, the water jet pulverizing device includes a frame, on which the transmission driving assembly and the plurality of support rollers are disposed. The plurality of support rollers are arranged at intervals in a left-right direction, and an axis of each of the plurality of support rollers extends in a front-rear direction.

Optionally, the water jet pulverizing device further includes a lifting frame, the plurality of support rollers include two movable rollers and a plurality of fixed rollers, the two movable rollers are spaced apart in the left-right direction, the plurality of fixed rollers are disposed between the two movable rollers, the movable rollers are movable in the left-right direction to tension the tire annular band, the transmission driving assembly is connected to the movable rollers, an axis of the grinding wheel extends in the front-rear direction, the grinding assembly and the lifting frame are disposed above the plurality of support rollers, an end portion of the grinding wheel is located in the lifting frame, and the grinding assembly and the lifting frame are synchronously movable in an up-down direction.

Optionally, two water jet assemblies are spaced apart in the left-right direction and both disposed above the plurality of support rollers, and the grinding assembly is located between the two water jet assemblies; the water jet assembly further includes a mounting base, a mounting slider, a screw and a linear guide rod; the crushing water jet, the mounting base and the mounting slider are connected in sequence, the screw and the linear guide rod both extend in the front-rear direction, the screw and the linear guide rod both pass through the mounting slider, the screw is connected to a servo motor, and the crushing water jet, the mounting base and the mounting slider are all reciprocally movable in the front-rear direction.

The present disclosure achieves the advantageous effects that the method for producing fine rubber powder from waste tires combines water jet crushing and grinding crushing, which enables efficient processing of rubber powder from waste tires and produces rubber powder with low iron impurity content.

### BRIEF DESCRIPTION OF DRAWINGS

The drawings constituting a part of the present disclosure are used to provide a further understanding of the present disclosure, and the schematic embodiments of the present disclosure and the descriptions thereof are used to explain, rather than improperly limit, the present disclosure.

FIG. 1 illustrates a cross-sectional view of a waste tire.

FIG. 2 illustrates a schematic diagram of a waste tire separated between a sidewall and a shoulder.

FIG. 3 illustrates a structural diagram of a water jet cutting device according to an embodiment.

FIG. 4 illustrates a structural diagram of a water jet cutting device according to another embodiment.

FIG. 5 illustrates a front perspective view of a water jet pulverizing device.

FIG. 6 illustrates a rear perspective view of a water jet pulverizing device.

FIG. 7 illustrates a schematic diagram of a water jet assembly.

FIG. 8 illustrates a schematic diagram of a water jet pulverizing device in a use state.

FIG. 9 illustrates a schematic diagram of a CPS disc centrifuge particle diameter analysis curve of rubber powder prepared in Example 7.

FIG. 10 illustrates a schematic diagram of a CPS disc centrifuge particle diameter analysis curve of rubber powder prepared in Example 7.

### REFERENCE NUMERALS

1: three-jaw chuck; 2: gear motor; 3: mechanical arm; 4: cutting water jet cutter;
5: gripping assembly; 6: worktable; 7: frame; 8: lifting frame;
9: water jet assembly; 10: grinding assembly; 11: waste tire;
101: arc-shaped supporting plate; 51: fixed limiting wheel; 52: movable limiting wheel;
53: driving wheel; 54: rotary drive motor; 55: swing arm; 56: bolt handle;
61: positioning post; 71: movable roller; 72: fixed roller; 73: tensioning slider;
74: adjusting hydraulic cylinder; 75: direct-drive gear motor;
81: lifting hydraulic cylinder; 82: guide post; 83: adjusting slider; 84: guide shaft;
85: buffer spring; 91: crushing water jet cutter; 92: mounting base; 93: mounting slider;
94: screw; 95: linear guide rod; 96: servo motor; 1001: grinding wheel; 1101: sidewall;
1102: shoulder; 1103: tire annular band; 1104: outer rim; 1105: inner rim; 1106: tread.

### DESCRIPTION OF EMBODIMENTS

It shall be noted that the embodiments of the present disclosure and the features in the embodiments may be combined with each other without conflict. The present disclosure will be described in detail below with reference to the drawings and in conjunction with the embodiments.

To facilitate the understanding and description, absolute positional relationships are adopted in the following description of the present disclosure. Unless otherwise specified, an orientation term “upper” refers to an upper direction in FIG. 8, an orientation term “lower” refers to a lower direction in FIG. 8, an orientation term “left” refers to a left direction in FIG. 8, an orientation term “right” refers to a right direction in FIG. 8, an orientation term “front” refers to a direction perpendicular to the plane of FIG. 8 and pointing inward therefrom, and an orientation term “rear” refers to a direction perpendicular to the plane of FIG. 8 and pointing outward therefrom. The present disclosure is described from the perspective of a reader or user, but the above orientation terms shall not be understood or construed as limiting the protection scope of the present disclosure. The dimensions and angles of the components can be specifically determined by those skilled in the art according to actual needs or through a limited number of tests.

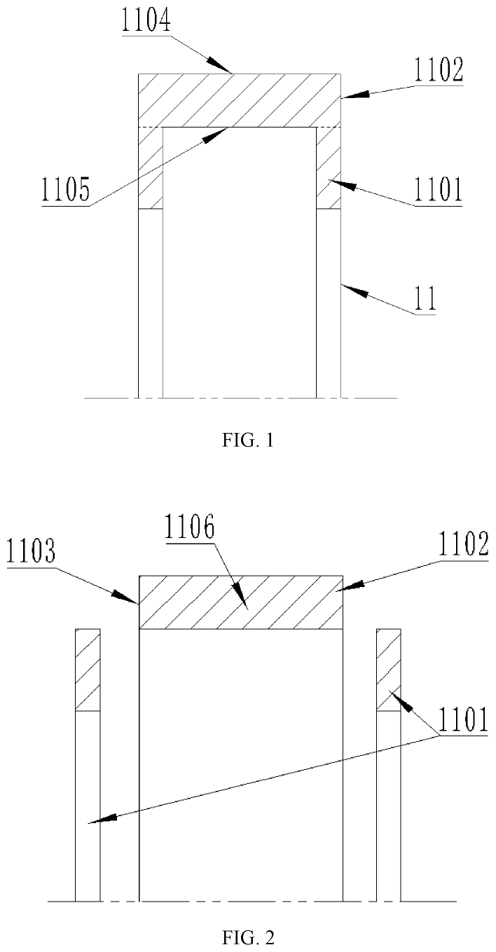

As illustrated in FIGS. 1, 2 and 8, a method for producing fine rubber powder from waste tires according to embodiments of the present disclosure sequentially includes:
Step 1: separating a waste tire 11 between a sidewall 1101 and a shoulder 1102 to obtain a tire annular band 1103 including a tread 1106 and the shoulder 1102; and
Step 2: maintaining the tire annular band 1103 in a tensioned state and rotating it circumferentially; cutting, by a water jet from a crushing water jet cutter 91 reciprocating in an axial direction of the tire annular band 1103, a surface of the tire annular band 1103 into a flocculent rubber structure not separated from the tire annular band 1103; and grinding, by a grinding assembly, the flocculent rubber structure on the surface of the tire annular band 1103 into fine rubber powder separated from the tire annular band 1103.

Through the above technical solution, by removing the sidewall of the tire, the portion of the tire subjected to water jet processing is formed into a regular annular band, so that when the tire annular band is mounted on a support provided with a plurality of support rollers, the tire annular band can be well tensioned to maintain a stable tensioned state. Moreover, when the tire annular band is driven to perform a circumferential circulating motion by the support rollers and/or a grinding wheel, the tire annular band can move in a stable and controllable state and trajectory, thereby realizing the process control of the crushing of the tire annular band by a water jet device, so as to achieve a high-quality, stable and controllable rubber powder morphology.

When the tire annular band is in circumferential circulating rotation between the grinding wheel and the support rollers, by setting the position and parameters of the water jet device, the water jet generated by the water jet device crushes the surface of the tire annular band, so that the rubber material on the surface of the tire annular band forms a flocculent structure not separated from a steel wire mesh. Further, through the grinding action of the grinding wheel on the tire annular band, the rubber of the flocculent structure on the surface of the tire annular band forms rubber powder separated from the tire annular band. Such processing does not damage a steel wire layer in the tire, so that the resulting rubber powder contains very few iron impurities, and conventional magnetic separation for iron removal is no longer required.

The water jet has extremely high kinetic energy. When the rubber on the tire annular band is pulverized, thermal energy generated by a chemical bond breakage and thermal energy converted from the kinetic energy may cause a high temperature of the rubber powder. Further, due to the small particle diameter, the rubber powder particles are also highly prone to agglomeration. By mixing the prepared rubber powder with a water stream or introducing it into a collection container filled with water, on the one hand, the water stream is used to rapidly cool the rubber powder, and on the other hand, the hydrophobicity of the rubber powder surface is exploited to disperse the rubber powder via the water stream, thereby preventing the rubber powder from agglomerating.

In Step 2, as illustrated in FIGS. 1 and 8, the tire annular band 1103 is stretched into a racetrack-shaped configuration, maintained in a tensioned state, and set into circumferential circulating rotation (similar to the circulating rotation of a conveyor belt). The grinding assembly 10 includes a grinding wheel 1001, which applies pressure to the tire annular band 1103 and grinds an outer circumferential surface (i.e., a surface with tread patterns) of the tire annular band 1103. The water jet assembly 9 includes a crushing water jet cutter 91, which performs hydraulic cutting and crushing on the outer circumferential surface of the tire annular band 1103 and reciprocates along the axial direction of the tire annular band 1103. Alternatively, the grinding assembly 10 may be replaced with any other existing grinding and cutting device capable of cutting rubber.

In Step 2, a water jet breaks up the surface of the tire annular band 1103, causing the rubber material on the surface of the tire annular band to form a flocculent structure not separated from the steel wire mesh. Meanwhile, the grinding wheel of the grinding assembly 10 is driven, and the tire annular band 1103 is in circumferential circulating rotation between the grinding wheel and the support rollers, so that the rubber of the flocculent structure on the surface of the tire annular band is abraded by the grinding wheel to form rubber powder separated from the tire annular band.

In Step 2, the pressure applied by the grinding wheel 1001 to the tire annular band 1103 is 7000 N to 10000 N. By controlling the pressure applied by the grinding wheel to the tire annular band, the grinding effect of the grinding wheel on the flocculent rubber on the tire annular band can be controlled.

In Step 2, the intensity of the water jet of the crushing water jet cutter 91 is 280 MPa to 400 MPa, and a standoff distance of the crushing water jet cutter 91 (i.e., a distance between the crushing water jet cutter 91 and the tire annular band 1103) is 15 mm to 50 mm. By controlling the intensity of the water jet and the standoff distance of the crushing water jet cutter 91, the water jet achieves optimal crushing performance on the tire annular band.

In Step 2, the circumferential rotational speed of the tire annular band 1103 is 500 mm/min to 1500 mm/min. When the tire annular band moves too rapidly, the contact time between the water jet and the cutting unit of the tire annular band is insufficient, preventing effective cutting and crushing of the surface of the tire annular band. When the tire annular band moves too slowly, the prolonged contact time between the water jet and the cutting unit of the tire annular band causes excessive cutting depth, damaging the steel wire mesh and introducing iron impurities. This also leads to localized overheating, adversely affecting the physical and chemical properties of the rubber powder. By controlling and adjusting the movement speed of the tire annular band, the processing efficiency and the processing quality of rubber powder crushing are fully coordinated during the processing of the tire annular band.

In Step 2, a mass fraction of the fine rubber powder with a mesh size of 200 mesh to 300 mesh is 65% to 95%. Compared with the prior art, the present disclosure can obtain fine rubber powder with better quality by adopting Step 1 and Step 2 as described above.

During the circumferential circulating rotation of the tire annular band 1103, Step 2 sequentially includes:
Step 2.1: performing hydraulic cutting and crushing on the tire annular band 1103 by the crushing water jet cutter 91; and
Step 2.2: grinding the tire annular band 1103 by the grinding assembly 10.

The method for producing fine rubber powder from waste tires further includes: Step 3: removing impurities from the fine rubber powder;
The Step 3 sequentially includes:

Step 3.1: placing the fine rubber powder into a collection container filled with water;
Step 3.2: performing magnetic separation on the fine rubber powder using a magnetic separator to remove iron, to obtain water-containing fine rubber powder; and
Step 3.3: draining and drying the water-containing fine rubber powder to obtain dry fine rubber powder.

In the Step 3.1, when the rubber powder is placed into the collection container filled with water, the collection container is provided with a stirring device and an ultrasonic oscillation device. Mechanical stirring and ultrasonic oscillation enable more efficient and sufficient dispersion of the rubber powder, such that agglomeration of the rubber powder particles is less likely to occur.

The method for producing fine rubber powder from waste tires further includes the following fine processing steps: Step 4: freezing and pulverizing the dry fine rubber powder to obtain ultra-fine rubber powder;

The Step 4 sequentially includes:
Step 4.1: placing the fine rubber powder into an environment of −130° C. to −70° C. for mechanical crushing, to obtain secondary rubber powder with a particle diameter ranging from 100 μm to 500 μm;
Step 4.2: sequentially placing the secondary rubber powder into a pre-freezing bin for pre-freezing at a pre-freezing temperature of −60° C. to −30° C. for a pre-freezing time of 20 s to 200 s;
Step 4.3: placing the pre-frozen secondary rubber powder into a deep-freezing bin for deep freezing at a deep freezing temperature of −196° C. to −80° C. for a deep freezing time of 60 s to 200 s; and
Step 4.4: grinding the deep-frozen secondary rubber powder to obtain the ultra-fine rubber powder.

Through the above technical solution, molecular motion of rubber almost completely ceases in a low-temperature environment of −130° C. to −70° C., and the material becomes extremely hard and brittle. Rubber in this state is prone to fracture under impact or pressure, and less energy is required during pulverization, thereby effectively improving pulverization efficiency. In addition, low-temperature pulverization reduces heat generated by friction, avoids the risk of pyrolysis or oxidation of rubber caused by frictional heat, and maintains the chemical stability of the rubber powder. After primary crushing of rubber at −130° C. to −70° C., the rubber powder is pre-frozen at −60° C. to −30° C. Since the pre-freezing temperature is higher than that during mechanical crushing, molecular motion of the rubber recovers to a certain extent, the material regains partial toughness, and rubber molecular chains are elongated due to stress release. After pre-freezing, the rubber powder is subjected to deep freezing. The instantaneous temperature difference between deep freezing and pre-freezing causes the elongated rubber molecular chains to break. Further, rapid crystallization of rubber occurs at −196° C. to −80° C. At this point, grinding and crushing the secondary rubber powder not only produces finer rubber powder, but also rearranges the molecular chains of the rubber powder, thereby improving the mechanical properties of the material.

In Step 4.2, the temperatures of the pre-freezing bins decrease stage by stage from a feed end to a discharge end for the secondary rubber powder, with a temperature difference of 10° C. to 15° C. between adjacent stages, and treatment time decreases stage by stage, with a time difference of 30 s to 60 s between adjacent stages.

Staged temperature reduction allows more uniform cooling of the rubber powder and avoids the internal stress or non-uniform crystallization caused by an excessively rapid temperature change. Controlling a temperature difference of 10° C. to 15° C. between adjacent stages helps the rubber powder to reach different physical states at different stages, facilitates the ordered arrangement of rubber molecular chains, and improves crystallization quality. Controlling a time difference of 30 s to 60 s between adjacent stages ensures sufficient time for the molecular rearrangement and crystallization of the rubber powder at each temperature stage, and prevents the degradation of material properties caused by excessively long exposure at a certain temperature. As the temperature decreases, the crystallization rate of the rubber powder gradually increases, so shortening the treatment time gradually avoids excessive crystallization or excessive molecular chain arrangement. Through gradual temperature reduction and time control, the crystallization process of the rubber powder is optimized to form more uniform and finer crystals at different temperatures, thereby improving the physical properties of the rubber powder.

Described below is an apparatus for producing fine rubber powder from waste tires, which is adopted by the method for producing fine rubber powder from waste tires. The apparatus for producing fine rubber powder from waste tires includes a cutting device and a water jet pulverizing device. The cutting device is configured to separate the waste tire 11 by cutting at a position (the dashed line in FIG. 1) between a sidewall 1101 and a shoulder 1102. The water jet pulverizing device includes a grinding assembly 10, a water jet assembly 9, a transmission driving assembly, and a plurality of support rollers. The tire annular band 1103 can be mounted around the plurality of support rollers that tension the tire annular band 1103. The transmission driving assembly can drive the tire annular band 1103 to rotate circumferentially through the support rollers. The water jet assembly 9 includes a crushing water jet cutter 91, which is configured to apply the water jet to the tire annular band 1103 to cut the surface of the tire annular band 1103 into a flocculent rubber structure not separated from the tire annular band 1103. The grinding assembly 10 includes a grinding wheel 1001, which is configured to grind the flocculent rubber structure on the surface of the tire annular band 1103.

The cutting device may be a water jet cutting device. The cutting device includes a tire fixing assembly, a cutting water jet cutter 4, and a driving assembly. The tire fixing assembly is a gripping assembly (also referred to as a gripping and fixing assembly) or a support assembly (also referred to as a supporting and fixing assembly). The gripping assembly is configured to grip and fix an outer rim 1104 of the waste tire 11, and the support assembly is configured to support and fix an inner rim 1105 of the waste tire 11. The cutting water jet cutter 4 is configured to cut the waste tire 11 into one tire annular band 1103 and two sidewalls 1101. The driving assembly is configured to drive the tire fixing assembly and the waste tire 11 to rotate.

For example, as illustrated in FIG. 3, the cutting device (i.e., the water jet cutting device) may be a horizontal structure. The cutting device includes a three-jaw chuck 1, a gear motor 2 for driving the three-jaw chuck 1 to rotate, a mechanical arm 3, and the cutting water jet cutter 4. The three-jaw chuck 1 may be used as a support device or a gripping device. An arc-shaped supporting plate 101 is fixed on a jaw of the three-jaw chuck 1. The mechanical arm 3 includes at least one degree of freedom of oscillating motion in a plane parallel to an end face of the tire. The cutting water jet cutter 4 is clamped and fixed on an end effector of the mechanical arm 3.

When the sidewall of the tire is cut and removed using the water jet cutting device, the tire is sleeved on the arc-shaped supporting plate 101 of the three-jaw chuck 1, so as to support the inner rim of the tire by the jaws of the three-jaw chuck 1. The three-jaw chuck 1 is driven to rotate by the gear motor 2, thereby driving the tire to rotate about its axis. The cutting water jet cutter 4 is moved by the mechanical arm 3 to a joint between the sidewall and the shoulder of the tire, and the water jet ejected by the cutting water jet cutter 4 is perpendicular to the end face of the tire. During rotation, the tire is cut by the water jet ejected by the cutting water jet cutter 4 to efficiently separate the sidewall from the shoulder of the tire.

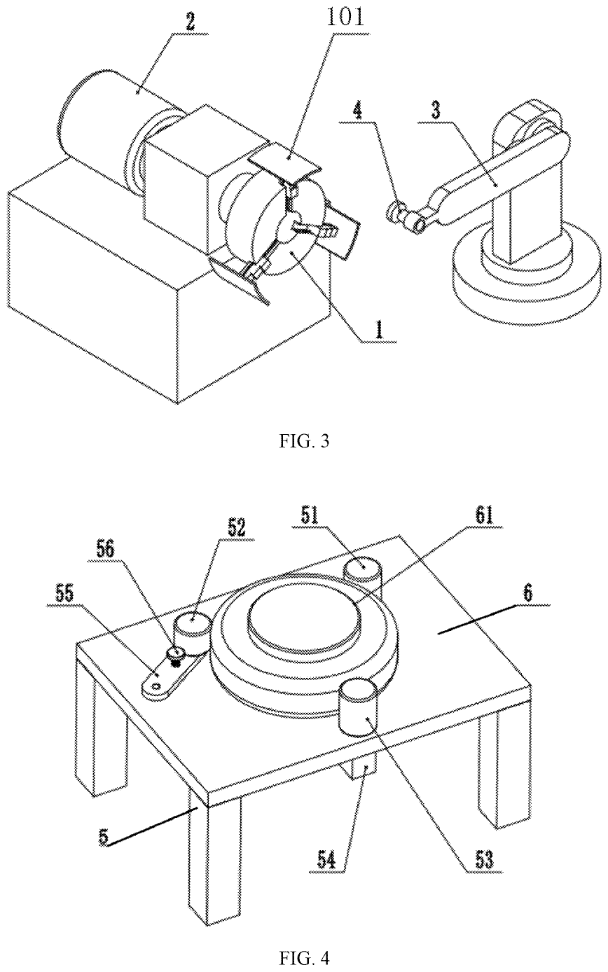

Alternatively, as illustrated in FIG. 4, the cutting device (i.e., the water jet cutting device) may be a vertical structure. The cutting device adopts the gripping assembly 5 for positioning the tire. The gripping assembly 5 includes a fixed limiting wheel 51, a movable limiting wheel 52, and a driving wheel 53. The water jet cutting device further includes a worktable 6, on which a positioning post 61 is fixed. The diameter of the positioning post 61 is slightly smaller than that of the inner rim of the tire, so that the tire can be easily sleeved on the positioning post 61. The circle centers of the fixed limiting wheel 51 and the driving wheel 53 are located on a same circle with the positioning post 61 as the center. The fixed limiting wheel 51 and the driving wheel 53 are rotatably connected to the worktable 6. A rotary drive motor 54 is disposed at the driving wheel 53, a body of the rotary drive motor 54 is fixedly connected to the worktable 6, and an output shaft of the rotary drive motor 54 is coaxially arranged and fixedly connected to the driving wheel 53.

A gripping device is disposed to grip the outer rim of the tire, or a support device is disposed to support the inner rim of the tire. The gripping device or the support device is driven to rotate by a driving device, so as to drive the tire to rotate around its axis. When the tire rotates, a water jet cutter parallel to the tire axis is aligned with a joint between the sidewall and the shoulder of the tire, and the sidewall and the shoulder of the tire are separated from each other under the action of the water jet ejected from the water jet cutter. By rotating the tire and cutting and separating the sidewall from the shoulder of the tire by the water jet ejected by the water jet cutter, this method achieves high efficiency, convenience, and environmental sustainability.

As illustrated in FIG. 4, a swing arm 55 is rotatably connected to the movable limiting wheel 52, and the other end of the swing arm 55 is rotatably connected to the worktable 6. A brake assembly for positioning the swing arm 55 is provided on the swing arm 55. In this embodiment, a bolt handle 56 is adopted as the brake assembly. The bolt handle 56 axially passes through the swing arm 55 and is threadedly connected to the swing arm 55. When being turned, the bolt handle 56 is pressed against the surface of the worktable 6, thereby positioning the swing arm 55. The positioning mode of the cutting water jet cutter 4 may be that as illustrated in FIG. 2 or any other positioning mode, with the only technical purpose of moving the cutting water jet cutter 4 to a joint between the sidewall and the shoulder of the tire, which will not be described in detail here. During water jet cutting of the tire, the tire is fitted on the positioning post 61 such that the tread of the tire is tangent to the fixed limiting wheel 51 and the driving wheel 53, respectively. The swing arm 55 is swung to bring the movable limiting wheel 52 into contact with the tire, and then the swing arm 55 is positioned. The rotary drive motor 54 is activated to rotate the tire about its axis under the action of the driving wheel 53, so that the sidewall and the shoulder of the tire are separated from each other by the water jet ejected from the cutting water jet cutter 4.

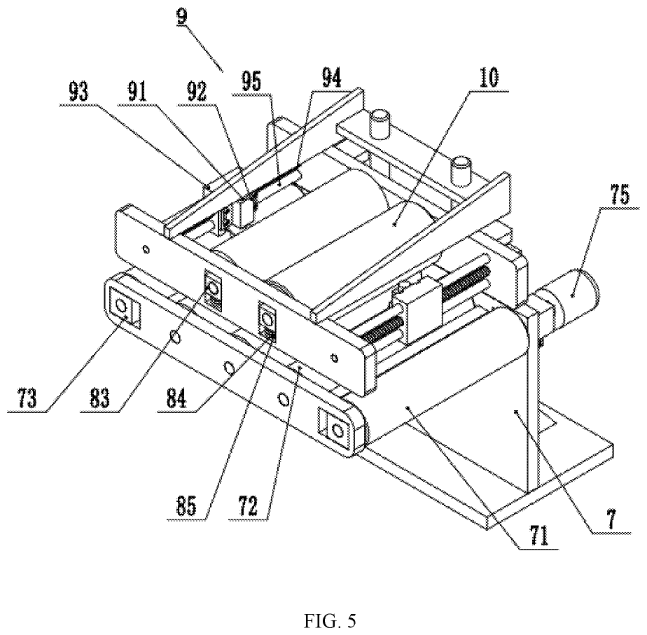

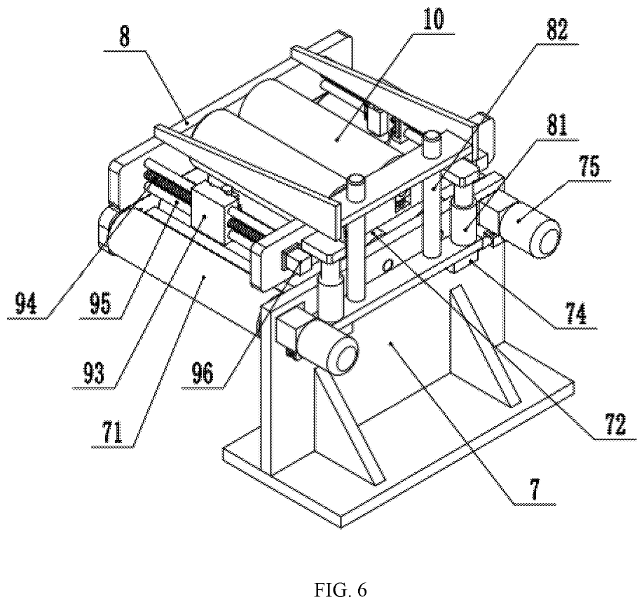

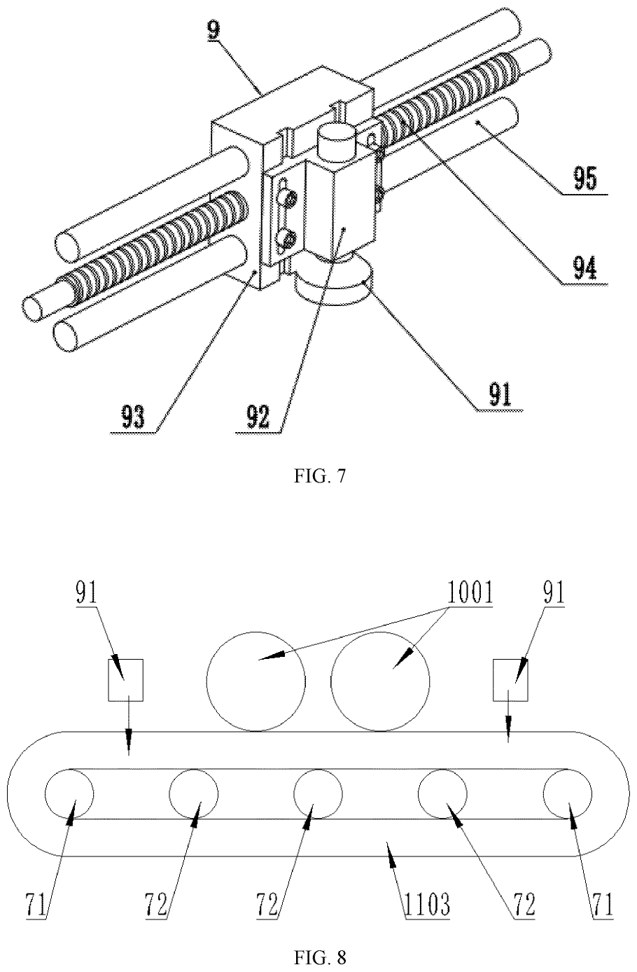

As illustrated in FIGS. 5 to 7, the water jet pulverizing device includes a frame 7, on which the transmission driving assembly and the plurality of support rollers are disposed. The plurality of support rollers are arranged at intervals in a left-right direction, and the axis of each of the plurality of support rollers extends in a front-rear direction. The tire annular band 1103 can be mounted around the plurality of support rollers, and the transmission driving assembly can drive the support rollers and the tire annular band 1103 to rotate. The plurality of support rollers include two movable rollers 71 and a plurality of (e.g., three) fixed rollers 72. The two movable rollers 71 are spaced apart in the left-right direction, and the plurality of fixed rollers 72 are disposed between the two movable rollers 71. The movable rollers 71 are movable in the left-right direction to tension the tire annular band 1103. The transmission driving assembly is connected to the movable rollers 71. The axis of the grinding wheel 1001 extends in the front-rear direction. The grinding assembly 10 and the lifting frame 8 are disposed above the plurality of support rollers. An end of the grinding wheel 1001 is located in the lifting frame 8, and the grinding assembly 10 and the lifting frame 8 are synchronously movable in an up-down direction.

Two ends of the movable roller 71 are respectively rotatably connected to tensioning sliders 73, which are slidably connected to the frame 7 along a longitudinal direction of the frame 7. The transmission driving assembly includes a direct-drive gear motor 75 configured to drive the movable roller 71 to rotate, a body of the direct-drive gear motor 75 is fixedly connected to the tensioning slider 73, and an output shaft of the direct-drive gear motor 75 is coaxially arranged and fixedly connected to the movable roller 71. Two ends of the fixed roller 72 are respectively rotatably connected to the frame 7. Each fixed roller 72 may be driven by a separate drive motor through belt drive or chain drive, or may be unpowered and rotated under the action of a conveyed object. The frame 7 is provided with an adjusting hydraulic cylinder 74 configured to drive the tensioning slider 73. The position of the movable roller 71 is adjusted by extending and retracting a piston rod of the adjusting hydraulic cylinder 74.

Before the tire annular band is mounted, the two movable rollers 71 are in a close position, so that a worker can conveniently sleeve the tire annular band onto the support rollers. After the tire annular band is mounted on the support rollers, the movable rollers 71 are driven to move away from each other, so as to tension the tire annular band fitted on the support rollers and keep the tire annular band in a proper tensioned state.

As illustrated in FIGS. 5 to 7, the lifting frame 8 is disposed above the support rollers, and the grinding wheel 1001 and the water jet assembly 9 are mounted on the lifting frame 8. The frame 7 is provided with a lifting hydraulic cylinder 81, a cylinder body of the lifting hydraulic cylinder 81 is fixedly connected to the frame 7, and a piston rod of the lifting hydraulic cylinder 81 is fixedly connected to the lifting frame 8. Extension and retraction of the piston rod of the lifting hydraulic cylinder 81 drives the lifting frame 8 to move up and down in the vertical direction. A plurality of vertically arranged guide posts 82 are fixed on the frame 7 to axially pass through the lifting frame 8 and guide the motion of the lifting frame 8, so that the motion of the lifting frame 8 is more stable.

The lifting motion of the lifting frame 8 moves the grinding wheel 1001 mounted thereon away from or towards the support rollers. When the grinding wheel 1001 approaches the support rollers, the grinding wheel 1001 compresses a buffer spring under the action of gravity and then abuts against the tire annular band 1103 to exert a force on the tire annular band 1103. Thus, when the tire annular band 1103 passes through the grinding wheel 1001, a good grinding effect can be achieved on the flocculent rubber on the surface of the tire annular band 1103.

The surface of the grinding wheel 1001 is provided with diamond patterns, or linear stripes extending along the axial direction of the grinding wheel 1001, so that the surface of the grinding wheel 1001 has a relatively high friction coefficient. Accordingly, when the tire annular band 1103 moves, the flocculent rubber on the surface of the tire annular band 1103 can be effectively ground.

As illustrated in FIGS. 5 and 6, adjusting sliders 83 are rotatably mounted at both ends of the grinding wheel 1001. A guide shaft 84 is fixed on the lifting frame 8 below the adjusting sliders 83. A buffer spring 85 is sleeved over the guide shaft 84, and two ends of the buffer spring 85 abut against the adjusting sliders 83 and the lifting frame 8 respectively. The grinding wheel 1001 may be driven or non-driven. When the grinding wheel 1001 is driven, the grinding assembly 10 further includes a rotary drive motor, which can drive the grinding wheel 1001 to rotate (about its own axis). The rotation direction of the grinding wheel 1001 is opposite to that of the support roller, and the linear speed of the grinding wheel 1001 is lower than that of the support roller, so as to achieve a good grinding effect on the crushed flocculent rubber on the surface of the tire annular band.

As illustrated in FIGS. 5 to 7, two water jet assemblies 9 are spaced apart in a left-right direction and both located above the plurality of support rollers, and the grinding assembly 10 is located between the two water jet assemblies 9. The water jet assembly 9 further includes a mounting base 92, a mounting slider 93, a screw 94 and a linear guide rod 95 which are connected in sequence. The crushing water jet cutter 91, the mounting base 92 and the mounting slider 93 are connected in sequence. The screw 94 and the linear guide rod 95 both extend in the front-rear direction and both pass through the mounting slider 93. The screw 94 is connected to a servo motor 96. The crushing water jet cutter 91, the mounting base 92 and the mounting slider 93 are all reciprocally movable in the front-rear direction. The mounting slider is driven by a crushing drive assembly to reciprocate in the axial direction of the support roller, so that the tread of the tire annular band is broken by the reciprocating water jet cutter, thereby achieving high crushing efficiency.

The mounting slider 93 is provided with threaded holes for fixing the mounting base 92. The mounting base 92 is provided with elongated holes matching the threaded holes, and the mounting base 92 is fixed to the mounting slider 93 by bolt connection. By loosening the bolts and sliding the mounting base 92 up and down, the height position of the mounting base 92 can be conveniently and quickly adjusted, thereby adjusting a target distance from the crushing water jet cutter 91 to the tire annular band. The crushing drive assembly includes a screw 94, at least a pair of linear guide rods 95, and a servo motor 96 that drives the screw 94 to rotate. The axis of the linear guide rod 95 is arranged parallel to the support roller. Both ends of the linear guide rod 95 are fixedly connected to the lifting frame 8 respectively. The linear guide rods 95 axially pass through the mounting slider 93, and the mounting slider 93 is slidably connected to the linear guide rods 95 in the axial direction thereof. The screw 94 axially passes through the mounting slider 93 and is threadedly engaged with the mounting slider 93. Forward and reverse rotation of the screw 94 driven by the servo motor 96 drives the mounting slider 93 to reciprocate in the axial direction of the support roller, so that the tire annular band can be broken efficiently.

The working principles of the cutting device and the water jet pulverizing device are described below.

In use, the water jet cutting device removes the sidewall 1101 of the tire and retains the tire annular band 1103. The tire annular band 1103 is mounted around the support rollers on the frame 7. Then the adjusting hydraulic cylinder 74 is actuated to extend the piston rod of the adjusting hydraulic cylinder 74, so that the two movable rollers 71 move away from the fixed roller 72, thereby tensioning the tire annular band 1103 mounted around the support rollers and maintaining the tire annular band 1103 in a favorable and stable tension state. The piston rod of the lifting hydraulic cylinder 81 is driven to extend and retract, thereby lowering the lifting frame 8 toward the frame 7. Under its own gravity, the grinding wheel 1001 compresses the buffer spring 85 and then abuts against the tire annular band. Driven by the support rollers, the tire annular band circulates between the support rollers and the grinding wheel 1001. Meanwhile, the servo motor 96 drives the screw 94 to rotate forward and reversely periodically, so that the mounting slider 93 drives the crushing water jet cutter 91 to reciprocate in the axial direction of the support rollers. Accordingly, the tire annular band 1103 is broken by the water jet ejected from the crushing water jet cutter 91, and the surface of the tire annular band 1103 is broken into flocculent rubber not separated from the steel wire layer. Then, the grinding wheel 1001 acts on the surface of the tire annular band 1103 to strip the rubber powder from the tire annular band.

The rotation driving assembly drives the support assembly or the gripping assembly to rotate, so that the motion trajectory of the cutting water jet cutter relative to the tire is a regular circle. The water jet of the cutting water jet cutter separates the sidewall from the shoulder, thereby maintaining a regular shape for the tire annular band to be mounted conveniently. Further, the tire annular band is mounted around the support rollers and tensioned by the support rollers, and then the grinding wheel is positioned to abut against the tire annular band. When the transmission driving assembly drives the tire annular band to move between the grinding wheel and the support roller, the water jet ejected from the crushing water jet cutter crushes the surface of the tire annular band, so that the rubber material on the surface of the tire annular band forms a flocculent structure not separated from the steel wire layer. Then, under the grinding action of the grinding wheel on the tire annular band, the rubber powder is gradually separated from the tire annular band. In this apparatus, the tire annular band is preliminarily broken by the water jet cutter, so that the rubber material on the surface of the tire annular band forms a flocculent structure not separated from the steel wire layer. The rubber powder is then separated from the tire annular band by abrasion, which hardly damages the steel wire layer. Accordingly, the content of iron impurities in the rubber powder is low, and the rubber powder with an extremely low iron content can be obtained only by one magnetic separation, thereby effectively improving the production efficiency of the rubber powder.

The practical application examples of the method and apparatus for producing fine rubber powder from waste tires are described below.

### Example 1

A method for producing fine rubber powder from waste tires, including the following steps in sequence:
Step 1: separating a waste tire 11 between a sidewall 1101 and a shoulder 1102 to obtain a tire annular band 1103 including a tread 1106 and the shoulder 1102;
Step 2: maintaining the tire annular band 1103 in a tensioned state and rotating it circumferentially at a speed of 500 mm/min, and enabling a crushing water jet cutter 91 to reciprocate in an axial direction of the tire annular band 1103 and apply a water jet to the tire annular band 1103, with a water jet intensity of the crushing water jet cutter 91 being 280 MPa, and a standoff distance of the crushing water jet cutter 91 being 15 mm, so as to cut a surface of the tire annular band 1103 into a flocculent rubber structure not separated from the tire annular band 1103; and applying a pressure of 8000 N to the tire annular band 1103 by the grinding wheel 1001, and grinding the flocculent rubber structure on the surface of the tire annular band 1103 by the grinding wheel 1001 into fine rubber powder separated from the tire annular band 1103; and
Step 3: removing impurities (e.g., iron scraps) from the fine rubber powder, and draining and drying the fine rubber powder to obtain dry fine rubber powder.

### Example 2

A method for producing fine rubber powder from waste tires, including the following steps in sequence:
Step 1: separating a waste tire 11 between a sidewall 1101 and a shoulder 1102 to obtain a tire annular band 1103 including a tread 1106 and the shoulder 1102;
Step 2: maintaining the tire annular band 1103 in a tensioned state and rotating it circumferentially at a speed of 500 mm/min, and enabling a crushing water jet cutter 91 to reciprocate in an axial direction of the tire annular band 1103 and apply a water jet to the tire annular band 1103, with a water jet intensity of the crushing water jet cutter 91 being 400 MPa, and a standoff distance of the crushing water jet cutter 91 being 15 mm, so as to cut a surface of the tire annular band 1103 into a flocculent rubber structure not separated from the tire annular band 1103; and applying a pressure of 8000 N to the tire annular band 1103 by the grinding wheel 1001, and grinding the flocculent rubber structure on the surface of the tire annular band 1103 by the grinding wheel 1001 into fine rubber powder separated from the tire annular band 1103; and
Step 3: removing impurities (e.g., iron scraps) from the fine rubber powder to remove impurities, and draining and drying the fine rubber powder to obtain dry fine rubber powder.

### Example 3

A method for producing fine rubber powder from waste tires, including the following steps in sequence:
Step 1: separating a waste tire 11 between a sidewall 1101 and a shoulder 1102 to obtain a tire annular band 1103 including a tread 1106 and the shoulder 1102;
Step 2: keeping the tire annular band 1103 in a tensioned state and rotating it circumferentially at a speed of 500 mm/min, and enabling a crushing water jet cutter 91 to reciprocate in an axial direction of the tire annular band 1103 and apply a water jet to the tire annular band 1103, with a water jet intensity of the crushing water jet cutter 91 being 280 MPa, and a standoff distance of the crushing water jet cutter 91 being 50 mm, so as to cut a surface of the tire annular band 1103 into a flocculent rubber structure not separated from the tire annular band 1103; and applying a pressure of 8000 N to the tire annular band 1103 by the grinding wheel 1001, and grinding the flocculent rubber structure on the surface of the tire annular band 1103 by the grinding wheel 1001 into fine rubber powder separated from the tire annular band 1103; and
Step 3: removing impurities (e.g., iron scraps) from the fine rubber powder, and draining and drying the fine rubber powder to obtain dry fine rubber powder.

### Example 4

A method for producing fine rubber powder from waste tires, including the following steps in sequence:
Step 1: separating a waste tire 11 between a sidewall 1101 and a shoulder 1102 to obtain a tire annular band 1103 including a tread 1106 and the shoulder 1102;
Step 2: maintaining the tire annular band 1103 in a tensioned state and rotating it circumferentially at a speed of 500 mm/min, and enabling a crushing water jet cutter 91 to reciprocate in an axial direction of the tire annular band 1103 and apply a water jet to the tire annular band 1103, with a water jet intensity of the crushing water jet cutter 91 being 400 MPa, and a standoff distance of the crushing water jet cutter 91 being 50 mm, so as to cut a surface of the tire annular band 1103 into a flocculent rubber structure not separated from the tire annular band 1103; and applying a pressure of 8000 N to the tire annular band 1103 by the grinding wheel 1001, and grinding the flocculent rubber structure on the surface of the tire annular band 1103 by the grinding wheel 1001 into fine rubber powder separated from the tire annular band 1103; and
Step 3: removing impurities (e.g., iron scraps) from the fine rubber powder, and draining and drying the fine rubber powder to obtain dry fine rubber powder.

### Example 5

A method for producing fine rubber powder from waste tires, including the following steps in sequence:
Step 1: separating a waste tire 11 between a sidewall 1101 and a shoulder 1102 to obtain a tire annular band 1103 including a tread 1106 and the shoulder 1102;
Step 2: maintaining the tire annular band 1103 in a tensioned state and rotating it circumferentially at a speed of 1000 mm/min, and enabling a crushing water jet cutter 91 to reciprocate in an axial direction of the tire annular band 1103 and apply a water jet to the tire annular band 1103, with a water jet intensity of the crushing water jet cutter 91 being 280 MPa, and a standoff distance of the crushing water jet cutter 91 being 15 mm, so as to cut a surface of the tire annular band 1103 into a flocculent rubber structure not separated from the tire annular band 1103; and applying a pressure of 8000 N to the tire annular band 1103 by the grinding wheel 1001, and grinding the flocculent rubber structure on the surface of the tire annular band 1103 by the grinding wheel 1001 into fine rubber powder separated from the tire annular band 1103; and
Step 3: removing impurities (e.g., iron scraps) from the fine rubber powder, and draining and drying the fine rubber powder to obtain dry fine rubber powder.

### Example 6

A method for producing fine rubber powder from waste tires, including the following steps in sequence:
Step 1: separating a waste tire 11 between a sidewall 1101 and a shoulder 1102 to obtain a tire annular band 1103 including a tread 1106 and the shoulder 1102;
Step 2: maintaining the tire annular band 1103 in a tensioned state and rotating it circumferentially at a speed of 1500 mm/min, and enabling a crushing water jet cutter 91 to reciprocate in an axial direction of the tire annular band 1103 and apply a water jet to the tire annular band 1103, with a water jet intensity of the crushing water jet cutter 91 being 280 MPa, and a standoff distance of the crushing water jet cutter 91 being 15 mm, so as to cut a surface of the tire annular band 1103 into a flocculent rubber structure not separated from the tire annular band 1103; and applying a pressure of 8000 N to the tire annular band 1103 by the grinding wheel 1001, and grinding the flocculent rubber structure on the surface of the tire annular band 1103 by the grinding wheel 1001 into fine rubber powder separated from the tire annular band 1103; and
Step 3: removing impurities (e.g., iron scraps) from the fine rubber powder, and draining and drying the fine rubber powder to obtain dry fine rubber powder.

### Example 7

This example uses the fine rubber powder prepared in Example 1 as a raw material for further fine processing, that is, the method for producing fine rubber powder from waste tires further includes the following fine processing.

The Step 4 sequentially includes:
Step 4.1: placing the fine rubber powder into an environment of −100° C. for mechanical crushing, so as to obtain secondary rubber powder with a particle diameter ranging from 100 μm to 500 μm; and
Step 4.2: sequentially placing the secondary rubber powder into a pre-freezing bin for pre-freezing at a pre-freezing temperature of −60° C. for a pre-freezing time of 200 s.

### Example 8

This example uses the fine rubber powder prepared in Example 1 as a raw material for further fine processing, that is, the method for producing fine rubber powder from waste tires further includes the following fine processing.

The Step 4 sequentially includes:
Step 4.1: placing the fine rubber powder into an environment of −100° C. for mechanical crushing, so as to obtain secondary rubber powder with a particle diameter ranging from 100 μm to 500 μm; and
Step 4.2: sequentially placing the secondary rubber powder into a plurality of pre-freezing bins for pre-freezing, where the temperatures of the pre-freezing bins decrease stage by stage from a feed end to a discharge end for the secondary rubber powder, and treatment time in the pre-freezing bins reduces stage by stage; first-stage freezing adopts an ambient temperature of −30° C. and a time of 120 s; second-stage freezing adopts a temperature of −45° C. and a time of 60 s; and third-stage freezing adopts a temperature of −60° C. and a time of 20 s;
Step 4.3: placing the pre-frozen secondary rubber powder into a deep-freezing bin for deep freezing, where the deep freezing temperature is −196° C., and the deep freezing time is 100 s; and
Step 4.4: grinding the deep-frozen secondary rubber powder to obtain the ultra-fine rubber powder.

### Comparative Example 1

A method for producing fine rubber powder from waste tires, including the following steps in sequence:
Step 1: separating a waste tire 11 between a sidewall 1101 and a shoulder 1102 to obtain a tire annular band 1103 including a tread 1106 and the shoulder 1102;
Step 2: maintaining the tire annular band 1103 in a tensioned state and rotating it circumferentially at a speed of 500 mm/min, and enabling a crushing water jet cutter 91 to reciprocate in an axial direction of the tire annular band 1103 and apply a water jet to the tire annular band 1103, with a water jet intensity of the crushing water jet cutter 91 being 250 MPa, and a standoff distance of the crushing water jet cutter 91 being 13 mm, so as to cut a surface of the tire annular band 1103 into a flocculent rubber structure not separated from the tire annular band 1103; and applying a pressure of 8000 N to the tire annular band 1103 by the grinding wheel 1001, and grinding the flocculent rubber structure on the surface of the tire annular band 1103 by the grinding wheel 1001 into fine rubber powder separated from the tire annular band 1103; and
Step 3: removing impurities (e.g., iron scraps) from the fine rubber powder, and draining and drying the fine rubber powder to obtain dry fine rubber powder.

### Comparative Example 2

A method for producing fine rubber powder from waste tires, including the following steps in sequence:
Step 1: separating a waste tire 11 between a sidewall 1101 and a shoulder 1102 to obtain a tire annular band 1103 including a tread 1106 and the shoulder 1102;
Step 2: maintaining the tire annular band 1103 in a tensioned state and rotating it circumferentially at a speed of 500 mm/min, and enabling a crushing water jet cutter 91 to reciprocate in an axial direction of the tire annular band 1103 and apply a water jet to the tire annular band 1103, with a water jet intensity of the crushing water jet cutter 91 being 450 MPa, and a standoff distance of the crushing water jet cutter 91 being 15 mm, so as to cut a surface of the tire annular band 1103 into a flocculent rubber structure not separated from the tire annular band 1103; and applying a pressure of 8000 N to the tire annular band 1103 by the grinding wheel 1001, and grinding the flocculent rubber structure on the surface of the tire annular band 1103 by the grinding wheel 1001 into fine rubber powder separated from the tire annular band 1103; and
Step 3: removing impurities (e.g., iron scraps) from the fine rubber powder to, and draining and drying the fine rubber powder to obtain dry fine rubber powder.

### Comparative Example 3

A method for producing fine rubber powder from waste tires, including the following steps in sequence:
Step 1: separating a waste tire 11 between a sidewall 1101 and a shoulder 1102 to obtain a tire annular band 1103 including a tread 1106 and the shoulder 1102;
Step 2: maintaining the tire annular band 1103 in a tensioned state and rotating it circumferentially at a speed of 500 mm/min, and enabling a crushing water jet cutter 91 to reciprocate in an axial direction of the tire annular band 1103 and apply a water jet to the tire annular band 1103, with a water jet intensity of the crushing water jet cutter 91 being 450 MPa, and a standoff distance of the crushing water jet cutter 91 being 60 mm, so as to cut a surface of the tire annular band 1103 into a flocculent rubber structure not separated from the tire annular band 1103; and applying a pressure of 8000 N to the tire annular band 1103 by the grinding wheel 1001, and grinding the flocculent rubber structure on the surface of the tire annular band 1103 by the grinding wheel 1001 into fine rubber powder separated from the tire annular band 1103; and
Step 3: removing impurities (e.g., iron scraps) from the fine rubber powder, and draining and drying the fine rubber powder to obtain dry fine rubber powder.

### Test Method

Take 1 kg each of rubber powder samples prepared in Examples 1 to 6 and Comparative Examples 1 to 3, then sieve the rubber powder samples using 20-mesh, 50-mesh, 100-mesh, 200-mesh and 300-mesh sieves, respectively. Weigh the rubber powder passing through each sieve, and calculate the mass percentage of the rubber powder passed through the sieve relative to the total rubber powder sample, with the data accurate to two decimal places. The calculation results are shown in Table 1, and the unit of mass percentage in Table 1 is 00.

TABLE 1
Test Data of Screening Mass Percentage of Examples
1 to 6 and Comparative Examples 1 to 3

| | Sieve | | | | |
|---|---|---|---|---|---|
| Test | Mass percentage | | | | |
| Example | 20-mesh | 50-mesh | 100-mesh | 200-mesh | 300-mesh |
| Example 1 | 97.22 | 89.44 | 73.46 | 48.46 | 7.63 |
| Example 2 | 96.36 | 90.51 | 74.21 | 48.52 | 8.42 |
| Example 3 | 97.48 | 91.35 | 72.64 | 47.48 | 8.17 |
| Example 4 | 95.41 | 90.37 | 73.24 | 45.54 | 7.35 |
| Example 5 | 96.56 | 90.64 | 72.57 | 46.32 | 7.26 |
| Example 6 | 94.53 | 89.54 | 72.35 | 46.47 | 6.32 |
| Comparative | 90.32 | 84.25 | 70.64 | 45.25 | 6.08 |
| Example 1 | | | | | |
| Comparative | 91.27 | 83.35 | 71.28 | 46.59 | 8.54 |
| Example 2 | | | | | |
| Comparative | 87.34 | 80.15 | 70.02 | 41.47 | 7.13 |
| Example 3 | | | | | |

As can be seen from the data in Table 1, the particle diameter of the rubber powder prepared through Steps 1 to 3 is concentrated in a range of 100 mesh to 200 mesh. That is, the rubber powder processed by the water jet in the present solution can be directly sieved to obtain 50-200 mesh rubber powder commonly used in the market without further secondary mechanical processing. Compared with the conventional mechanical crushing method, the rubber powder can be prepared more efficiently. When the water jet intensity and the standoff distance exceed the set ranges, the proportion of particles smaller than 50 mesh is increased significantly. This is because, when the standoff distance is kept constant, the water jet with excessively high intensity directly causes part of the uncrushed rubber powder to be separated from the tire annular band by cutting, resulting in an increase in large-particle rubber powder. When the water jet intensity is excessively low, the water jet cannot achieve a satisfactory crushing effect on the tire annular band, such that the tire annular band cannot be completely cut through, which also leads to an increase in large-particle rubber powder. When the target distance of the water jet is excessively large, the ejected water jet will inevitably cause the deviation of crushing positions and the dispersion of crushing areas under the action of gravity and air flow, thereby affecting the crushing effect of the water jet.

Iron impurity content detection is performed on the rubber powder samples prepared in Examples 1 to 6 and Comparative Examples 1 to 3. The iron impurity content in the rubber powder samples is detected according to the method specified in Chinese National Standard GB/T 19208-2020. The specific method is as follows:

Weigh 50 g of sample using a pallet balance with a sensitivity of 0.01 g and placed the sample on a non-magnetic flat surface. Place a small horseshoe magnet on the sample for 60 s. Then, use a coarse brush to remove the adsorbed material on the horseshoe magnet until all magnetic material adsorbed on the magnet and the brush is completely removed. Place the collected metal debris on a balance with a sensitivity of 0.0001 g for weighing, and calculate the iron content (%). The calculation results are accurate to two decimal places. The test results are shown in Table 2.

TABLE 2
Test Data of Iron Content of Examples 1 to 6 and Comparative Examples 1 to 3

| | Test example | | | | | | | | |
|---|---|---|---|---|---|---|---|---|---|
| | | | | | | | Comparative | Comparative | Comparative |
| | Example 1 | Example 2 | Example 3 | Example 4 | Example 5 | Example 6 | example 1 | example 2 | example 3 |
| Iron | 0.03 | 0.02 | 0.03 | 0.03 | 0.03 | 0.03 | 0.03 | 0.52 | 0.48 |
| content/% | | | | | | | | | |

The Chinese national standard GB/T 19208-2020 specifies the technical requirements for reclaimed rubber production and vulcanized rubber powder for other uses, in which the technical requirements for iron content are listed in Table 3.

TABLE 3
Iron Content Requirements for Reclaimed Rubber Production
and Vulcanized Rubber Powder for Other Uses

| | Detection item | | | | | | | | | |
|---|---|---|---|---|---|---|---|---|---|---|
| | Tire | | | Synthetic rubber | | | Road- | Waterproof | Waterproof | Others |
| | A1 | A2 | A3 | B1 | B2 | B3 | use | Type I | Type II | C |
| Iron | 0.05 | 0.05 | 0.05 | 0.05 | 0.05 | 0.05 | 0.05 | 0.05 | 0.05 | — |
| content/% | | | | | | | | | | |

Data from Tables 1 and 2 indicate that the proposed method for tire crushing achieves the required iron content for all categories of rubber powder with just one-time magnetic separation for iron removal, demonstrating high processing efficiency. With reference to the comparative examples, when the water jet intensity is greater than a critical value or the standoff distance is smaller than a critical value, the water jet will damage the steel wire layer of the tire annular band, thereby introducing a large amount of iron impurities into the rubber powder, and causing a sharp increase in the iron content in the rubber powder. As a result, the iron content of the prepared rubber powder cannot meet the application requirements for specific occasions by one-time magnetic separation, and multiple magnetic separation for iron removal is required.

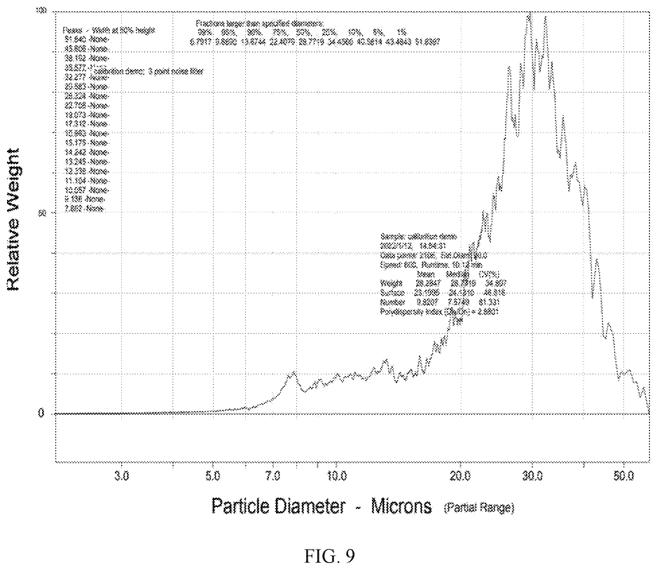

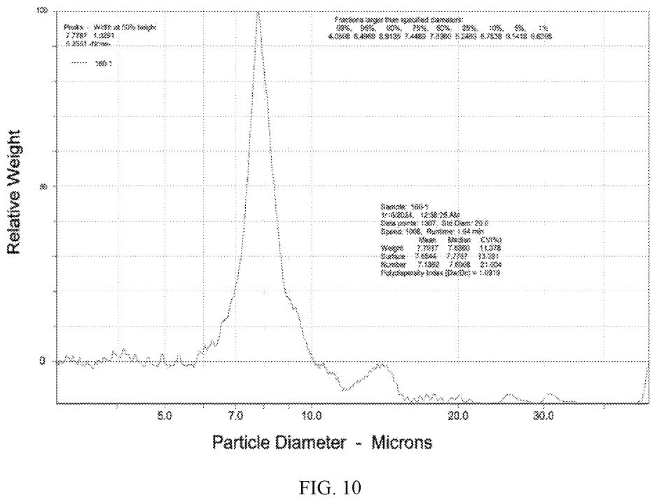

The particle diameters of the rubber powder prepared in Examples 7 and 8 are analyzed by a disc centrifugal nanoparticle diameter analyzer to obtain the particle diameter analysis curves illustrated in FIGS. 9 and 10, where FIG. 9 illustrates a particle diameter analysis curve of Example 7, and FIG. 10 illustrates a particle diameter analysis curve of Example 8.

As can be seen from the analysis of FIG. 9, the particle diameter of the rubber powder prepared in Example 7 is highly concentrated in a range of 20 μm to 50 μm. As can be seen from FIG. 10, deep processing of the prepared rubber powder can further effectively reduce the particle diameter of the rubber powder and make the particle diameter highly concentrated, thereby enabling the rubber powder to be applied in fields with higher requirements on the particle diameter of rubber particles, such as high-end coatings and surface modifiers.

In Example 8, a stage-by-stage freezing method is adopted for pre-freezing. For the secondary rubber powder, the temperatures of the pre-freezing bins decrease in sequence from the feed end to the discharge end, and treatment time in the pre-freezing bins is also reduces in sequence. As can be seen from FIG. 10, the prepared rubber powder particles have a smaller particle diameter and a more concentrated particle diameter distribution, and the particle diameter is highly concentrated in a range of 6 μm to 10 μm.

Those described above are merely specific embodiments of the present disclosure and shall not be used to limit the scope of the present disclosure. Therefore, the replacement of equivalent components thereof, as well as equivalent changes and modifications made in accordance with the protection scope of the present disclosure, shall still fall within the scope of the present disclosure. In addition, any combination among the technical features, between technical features and technical solutions, and among technical solutions in the present disclosure is freely allowed.

1. A method for producing fine rubber powder from waste tires, comprising:
Step 1: separating a waste tire between a sidewall and a shoulder to obtain a tire annular band comprising a tread and the shoulder; and
Step 2: maintaining the tire annular band in a tensioned state and rotating it circumferentially; cutting, by a water jet from a crushing water jet cutter reciprocating in an axial direction of the tire annular band, a surface of the tire annular band into a flocculent rubber structure not separated from the tire annular band; and grinding, by a grinding assembly, the flocculent rubber structure on the surface of the tire annular band into fine rubber powder separated from the tire annular band.

2. The method for producing fine rubber powder from waste tires according to claim 1, wherein the Step 2 comprises:
Step 2.1: applying a water jet to the tire annular band by the crushing water jet cutter to cut a surface of the tire annular band into a flocculent rubber structure not separated from the tire annular band; and
Step 2.2: grinding the flocculent rubber structure on the surface of the tire annular band by the grinding assembly.

3. The method for producing fine rubber powder from waste tires according to claim 1, further comprising: Step 3: removing impurities from the fine rubber powder;
wherein the Step 3 comprises:
Step 3.1: placing the fine rubber powder into a collection container filled with water;
Step 3.2: performing magnetic separation on the fine rubber powder using a magnetic separator to remove iron; and
Step 3.3: draining and drying the fine rubber powder.

4. The method for producing fine rubber powder from waste tires according to claim 3, further comprising: Step 4: freezing and pulverizing the fine rubber powder to obtain ultra-fine rubber powder;
wherein the Step 4 comprises:
Step 4.1: placing the fine rubber powder into an environment of −130° C. to −70° C. for mechanical crushing, to obtain secondary rubber powder with a particle diameter ranging from 100 μm to 500 μm;
Step 4.2: sequentially placing the secondary rubber powder into pre-freezing bins for pre-freezing at a pre-freezing temperature of −60° C. to −30° C. for a pre-freezing time of 20 s to 200 s;
Step 4.3: placing the pre-frozen secondary rubber powder into a deep-freezing bin for deep freezing at a deep freezing temperature of −196° C. to −80° C. for a deep freezing time of 60 s to 200 s; and
Step 4.4: grinding the deep-frozen secondary rubber powder to obtain the ultra-fine rubber powder.

5. The method for producing fine rubber powder from waste tires according to claim 4, wherein in the Step 4.2, temperatures of the pre-freezing bins decrease stage by stage from a feed end to a discharge end for the secondary rubber powder with a temperature difference of 10° C. to 15° C. between adjacent stages, and treatment time in the pre-freezing bins reduce stage by stage, with a time difference of 30 s to 60 s between adjacent stages.

6. The method for producing fine rubber powder from waste tires according to claim 1, wherein in the Step 2, the grinding assembly comprises a grinding wheel, which applies a pressure of 7000 N to 10000 N onto the tire annular band.

7. The method for producing fine rubber powder from waste tires according to claim 1, wherein in the Step 2, an intensity of the water jet of the crushing water jet cutter is 280 MPa to 400 MPa, and a standoff distance of the crushing water jet cutter is 15 mm to 50 mm.

8. The method for producing fine rubber powder from waste tires according to claim 1, wherein in the Step 2, a circumferential rotational speed of the tire annular band is 500 mm/min to 1500 mm/min.

9. The method for producing fine rubber powder from waste tires according to claim 1, wherein in the Step 2, the grinding assembly comprises a grinding wheel, an outer circumferential surface of which is provided with diamond patterns, or linear stripes extending along an axial direction of the grinding wheel.

10. The method for producing fine rubber powder from waste tires according to claim 1, wherein in the Step 2, the grinding assembly comprises a grinding wheel, a rotation direction of which is opposite to that of the tire annular band.

11. The method for producing fine rubber powder from waste tires according to claim 1, wherein in the Step 2, a mass fraction of the fine rubber powder with a mesh size of 200 mesh to 300 mesh is 65% to 95%.

12. The method for producing fine rubber powder from waste tires according to claim 1, wherein in the Step 1, a gripping device is disposed to grip an outer rim of the waste tire, or a support device is disposed to support an inner rim of the waste tire; the gripping device or the support device is driven to rotate by a driving device, causing the waste tire to rotate around its axis, and when the waste tire rotates, a cutting water jet parallel to the axis of the waste tire is aligned with a joint position between the sidewall and the shoulder, and the sidewall and the shoulder are separated from each other under the action of the water jet ejected from the water jet cutter.

13. The method for producing fine rubber powder from waste tires according to claim 3, wherein in the Step 3.1, when the fine rubber powder is placed into the collection container filled with water, the collection container is equipped with a stirring device and an ultrasonic oscillation device.

14. An apparatus for producing fine rubber powder from waste tires, which is adapted for use in the method for producing fine rubber powder from waste tires according to claim 1, the apparatus for producing fine rubber powder from waste tires comprising a cutting device and a water jet pulverizing device;
the cutting device is configured to separate the waste tire by cutting between a sidewall and a shoulder;
the water jet pulverizing device comprises a grinding assembly, a water jet assembly, a transmission driving assembly, and a plurality of support rollers;
the tire annular band is capable of being mounted around the plurality of support rollers that maintain the tire annular band in the tensioned state, and the transmission driving assembly is configured to drive the tire annular band to rotate circumferentially through the support rollers;
the water jet assembly comprises a crushing water jet cutter, which is configured to apply the water jet to the tire annular band to cut the surface of the tire annular band into the flocculent rubber structure not separated from the tire annular band; and
the grinding assembly comprises a grinding wheel, which is configured to grind the flocculent rubber structure on the surface of the tire annular band.

15. The apparatus for producing fine rubber powder from waste tires according to claim 14, wherein the cutting device is a water jet cutting device, and the cutting device comprises a tire fixing assembly, a cutting water jet cutter, and a driving assembly;
the tire fixing assembly is a gripping assembly or a support assembly, the gripping assembly is configured to grip and fix an outer rim of the waste tire, and the support assembly is configured to support and fix an inner rim of the waste tire;
the cutting water jet cutter is configured to cut the waste tire, and the driving assembly is configured to drive the tire fixing assembly to rotate.

16. The apparatus for producing fine rubber powder from waste tires according to claim 14, wherein the water jet pulverizing device comprises a frame, on which the transmission driving assembly and the plurality of support rollers are disposed;
the plurality of support rollers are arranged at intervals in a left-right direction, and an axis of each of the plurality of support rollers extends in a front-rear direction.

17. The apparatus for producing fine rubber powder from waste tires according to claim 16, wherein the water jet pulverizing device further comprises a lifting frame, the plurality of support rollers include two movable rollers and a plurality of fixed rollers, the two movable rollers are spaced apart in the left-right direction, the plurality of fixed rollers are disposed between the two movable rollers, the movable rollers are movable in the left-right direction to tension the tire annular band, the transmission driving assembly is connected to the movable rollers, an axis of the grinding wheel extends in the front-rear direction, the grinding assembly and the lifting frame are disposed above the plurality of support rollers, an end portion of the grinding wheel is located in the lifting frame, and the grinding assembly and the lifting frame are synchronously movable in an up-down direction.

18. The apparatus for producing fine rubber powder from waste tires according to claim 17, wherein two water jet assemblies are spaced apart in the left-right direction and both disposed above the plurality of support rollers, and the grinding assembly is located between the two water jet assemblies;
the water jet assembly further comprises a mounting base, a mounting slider, a screw and a linear guide rod;
the crushing water jet, the mounting base and the mounting slider are connected in sequence, the screw and the linear guide rod both extend in the front-rear direction, the screw and the linear guide rod both pass through the mounting slider, the screw is connected to a servo motor, and the crushing water jet, the mounting base and the mounting slider are all reciprocally movable in the front-rear direction.
